(19) United States
(12) Patent Application Publication
(10) Pub. No.: US 2017/0046615 A1
(43) Pub. Date: Feb. 16, 2017

(54) OBJECT CATEGORIZATION USING STATISTICALLY-MODELED CLASSIFIER OUTPUTS

(71) Applicant: Lyrical Labs Video Compression Technology, LLC, New York, NY (US)

(72) Inventors: Daniel Riley Schupp-Omid, Iowa City, IA (US); Edward Ratner, Iowa City, IA (US); Andrey Gritsenko, Stavropol (RU)

(21) Appl. No.: 15/237,048

(22) Filed: Aug. 15, 2016

Related U.S. Application Data
(60) Provisional application No. 62/204,925, filed on Aug. 13, 2015.

(51) Int. Cl. G06N 3/08; G06N 7/00

(52) U.S. Cl. CPC G06N 3/08; G06N 7/005

(57) ABSTRACT

Systems and method for object characterization include generating a classifier that defines a decision hyperplane separating a first classification region of a virtual feature space from a second classification region of the virtual feature space. Input information is provided to the classifier, and a number of classifications are received from the classifier. A distribution of the classifications is determined and used to generate a prediction.

### CROSS-REFERENCE TO RELATED APPLICATION

This application claims priority to U.S. Provisional Application No. 62/204,925, filed on Aug. 13, 2015, the entirety of which is hereby incorporated by reference for all purposes.

### BACKGROUND

In the field of pattern recognition, an increasingly popular strategy has involved fusing a number of classifiers for a more robust labeling scheme. The typical pipeline for such a technique involves extracting meaningful features from the data via common approaches such as kernel-based approaches (e.g. Laplacian of Gaussian, Sobel, etc.) and/or nonlinear features (e.g. Canny, SURF, etc.). After feature vectors are extracted, a learning algorithm (e.g., SVM, neural network, etc.) is used to train a classifier. Approaches such as deep learning seek to use cascaded classifiers (e.g., neural networks) to combine together the decisions from disparate feature sets into one decision.

### SUMMARY

Embodiments of the invention involve characterizing the output of a classifier using a histogram, and applying classical Bayesian decision theory on the result to build a statistically-backed prediction. Embodiments of this approach may facilitate improved accuracy and/or computational efficiency. For example, embodiments of the technique may be implemented in a modular manner, in that models may be trained independently, and added to the boosting stage ad-hoc, thereby potentially improving accuracy on the fly. As another example, by implementing a model that automatically provides a statistical model of a number of classifier outputs, computational efficiencies may be realized due, at least in part, to avoiding complex schemes for using cascaded classifiers to combine together the decisions from disparate features sets. Embodiments of the techniques and systems described herein may be applicable to any number of different situations in which classifiers are used, and although pattern recognition is one example, and any other situation in which one or more classifiers are utilized is contemplated herein.

In an Example 1, a method of object categorization comprises: generating at least one classifier, the at least one classifier defining at least one decision hyperplane that separates a first classification region of a virtual feature space from a second classification region of the virtual feature space; providing input information to the at least one classifier; receiving, from the at least one classifier, a plurality classifications corresponding to the input information; determining a distribution of the plurality of classifications; and generating a prediction based on the distribution.

In an Example 2, the method of Example 1, wherein determining a distribution of the plurality of classifications comprises characterizing the plurality of classifications using a histogram.

In an Example 3, the method of Example 2, wherein characterizing the plurality of classifications using a histogram comprises: computing a plurality of distances features, wherein each of the plurality of distance features comprises a distance, in the virtual feature space, between one of the classifications and the hyperplane; and assigning each of the plurality of distance features to one of a plurality of bins of a histogram.

In an Example 4, the method of Example 3, further comprising: determining a data density associated with a bin of the histogram; determining that the data density is below a threshold, wherein the threshold corresponds to a level of statistical significance; and modeling the distribution of data in the bin using a modeled distribution.

In an Example 5, the method of Example 4, further comprising backfilling the bin with probabilities from the modeled distribution.

In an Example 6, the method of any of Examples 4 or 5, wherein the modeled distribution comprises a Cauchy distribution.

In an Example 7, the method of any of the preceding Examples, wherein generating the prediction comprises estimating, using a decision function, a probability associated with the distribution.

In an Example 8, the method of Example 7, wherein the decision function utilizes at least one of Bayes estimation, positive predictive value (PPV) maximization, and negative predictive value (NPV) maximization.

In an Example 9, the method of any of the preceding Examples, wherein the at least one classifier comprises at least one of a support vector machine (SVM), an extreme learning machine (ELM), a neural network, a kernel-based perceptron, and a k-NN classifier.

In an Example 10, the method of any of the preceding Examples, further comprising generating the input information by extracting one or more features from a data set using one or more feature extractors.

In an Example 11, the method of Example 10, wherein the data set comprises digital image data and wherein generating the prediction facilitates a pattern recognition process.

In an Example 12, a system for object categorization, the system comprising: a memory having one or more computer-executable instructions stored thereon; and a processor configured to access the memory and to execute the computer-executable instructions, wherein the computer-executable instructions are configured to cause the processor, upon execution, to instantiate at least one component, the at least one component comprising: a classifier configured to receive input information, the classifier defining at least one decision hyperplane that separates a first classification region of a virtual feature space from a second classification region of the virtual feature space; a distribution builder configured to receive, from the classifier, a plurality of classifications corresponding to the input information, and to determine a distribution of the plurality of classifications; and a predictor configured to generate a prediction based on the distribution.

In an Example 13, the system of Example 12, wherein the distribution builder is configured to determine the distribution by characterizing the plurality of classifications using a histogram.

In an Example 14, the system of Example 13, wherein the distribution builder is configured to characterize the plurality of classifications using a histogram by: computing a plurality of distances features, wherein each of the plurality of distance features comprises a distance, in the virtual feature space, between one of the classifications and the hyperplane; and assigning each of the plurality of distance features to one of a plurality of bins of a histogram.

In an Example 15, the system of Example 14, wherein the distribution builder is further configured to characterize the plurality of classifications using a histogram by: determining a data density associated with a bin of the histogram; determining that the data density is below a threshold, wherein the threshold corresponds to a level of statistical significance; and modeling the distribution of data in the bin using a modeled distribution.

In an Example 16, the system of Example 15, wherein the distribution builder is further configured to characterize the plurality of classifications using a histogram by backfilling the bin with probabilities from the modeled distribution.

In an Example 17, the system of any of Examples 15 or 16, wherein the modeled distribution comprises a Cauchy distribution.

In an Example 18, the system of any of Examples 12-17, wherein the predictor is configured to generate the prediction by estimating, using a decision function, a probability associated with the distribution.

In an Example 19, the system of Example 18, wherein the decision function utilizes at least one of Bayes estimation, positive predictive value (PPV) maximization, and negative predictive value (NPV) maximization.

In an Example 20, the system of any of Examples 12-19, wherein the at least one classifier comprises at least one of a support vector machine (SVM), an extreme learning machine (ELM), a neural network, a kernel-based perceptron, and a k-NN classifier.

In an Example 21, the system of any of Examples 12-20, further comprising a feature extractor configured to generate the input information by extracting one or more features from a data set.

In an Example 22, the system of Example 21, wherein the data set comprises digital image data and wherein the predictor facilitates a pattern recognition process.

In an Example 23, one or more computer-readable media having computer-executable instructions embodied thereon for object categorization, the instructions configured to be executed by a processor and to cause the processor, upon execution, to instantiate at least one component, the at least one component comprising: a classifier configured to receive input information, the classifier defining at least one decision hyperplane that separates a first classification region of a virtual feature space from a second classification region of the virtual feature space; a distribution builder configured to receive, from the classifier, a plurality of classifications corresponding to the input information, and to determine a distribution of the plurality of classifications; and a predictor configured to generate a prediction based on the distribution.

In an Example 24, the media of Example 23, wherein the distribution builder is configured to determine the distribution by characterizing the plurality of classifications using a histogram.

In an Example 25, the media of Example 24, wherein the distribution builder is configured to characterize the plurality of classifications using a histogram by: computing a plurality of distances features, wherein each of the plurality of distance features comprises a distance, in the virtual feature space, between one of the classifications and the hyperplane; and assigning each of the plurality of distance features to one of a plurality of bins of a histogram.

In an Example 26, the media of Example 25, wherein the distribution builder is further configured to characterize the plurality of classifications using a histogram by: determining a data density associated with a bin of the histogram; determining that the data density is below a threshold, wherein the threshold corresponds to a level of statistical significance; and modeling the distribution of data in the bin using a modeled distribution.

In an Example 27, the media of Example 26, wherein the distribution builder is further configured to characterize the plurality of classifications using a histogram by backfilling the bin with probabilities from the modeled distribution.

In an Example 28, the media of any of Examples 26 or 27, wherein the modeled distribution comprises a Cauchy distribution.

In an Example 29, the media of any of Examples 23-28, wherein the predictor is configured to generate the prediction by estimating, using a decision function, a probability associated with the distribution.

In an Example 30, the media of Example 29, wherein the decision function utilizes at least one of Bayes estimation, positive predictive value (PPV) maximization, and negative predictive value (NPV) maximization.

In an Example 31, the media of any of Examples 23-30, wherein the at least one classifier comprises at least one of a support vector machine (SVM), an extreme learning machine (ELM), a neural network, a kernel-based perceptron, and a k-NN classifier.

In an Example 32, the media of any of Examples 23-31, further comprising a feature extractor configured to generate the input information by extracting one or more features from a data set.

In an Example 33, the media of Example 32, wherein the data set comprises digital image data and wherein the predictor facilitates a pattern recognition process.

### BRIEF DESCRIPTION OF THE DRAWINGS

FIG. 1 is a block diagram depicting an illustrative image system, in accordance with embodiments of the present invention;

FIG. 2 is a block diagram illustrating an operating environment (and, in some embodiments, aspects of the present invention), in accordance with embodiments of the present invention;

FIG. 3 is a schematic block diagram depicting an illustrative process for pattern recognition using object classification, in accordance with embodiments of the present invention;

FIG. 4 is a flow diagram depicting an illustrative method of pattern recognition training using object classification, in accordance with embodiments of the present invention;

FIG. 5 is a flow diagram depicting an illustrative method of object classification training, in accordance with embodiments of the present invention;

FIG. 6 is a flow diagram depicting an illustrative method of object classification, in accordance with embodiments of the present invention; and

FIGS. 7A and 7B are graphs depicting illustrative classification distributions, in accordance with embodiments of the present invention.

While the present invention is amenable to various modifications and alternative forms, specific embodiments have been shown by way of example in the drawings and are described in detail below. The present invention, however, is not limited to the particular embodiments described. On the contrary, the present invention is intended to cover all modifications, equivalents, and alternatives falling within the ambit of the present invention as defined by the appended claims.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

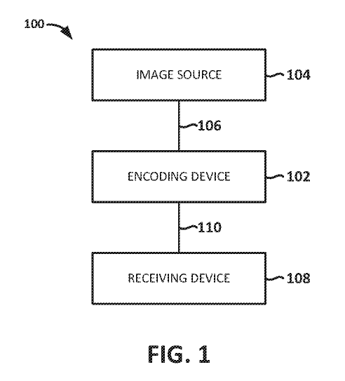

FIG. 1 depicts an illustrative image system 100 having an encoding device 102. The encoding device 102 is illustratively coupled to an image source 104 by a communication link 106. In embodiments, the encoding device 102 illustratively receives an image file from the image source 104 over the communication link 106. Exemplary image files include, but are not limited to, digital photographs, digital image files from medical imaging, machine vision image files, video image files, and any other suitable images having a plurality of pixels. Encoding device 102 is illustratively coupled to a receiving device 108 by a communication link 110. In embodiments, the encoding device 102 communicates an image file over the communication link 110. In some embodiments, communication links 106 and/or 110 independently are, include, or are included in a wired network, a wireless network, or a combination of wired and wireless networks. In embodiments, one or both of communication links 106 and 110 are a network. Illustrative networks include any number of different types of communication networks such as, a short messaging service (SMS), a local area network (LAN), a wireless LAN (WLAN), a wide area network (WAN), the Internet, a P2P network, or other suitable networks. The network may include a combination of multiple networks.

Although not illustrated herein, the receiving device 108 may include any combination of components described herein with reference to the encoding device 102, components not shown or described, and/or combinations of these. In embodiments, the encoding device 102 may include, or be similar to, the encoding computing systems described in U.S. application Ser. No. 13/428,707, filed Mar. 23, 2012, entitled “VIDEO ENCODING SYSTEM AND METHOD;” and/or U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION;” the disclosure of each of which is expressly incorporated by reference herein.

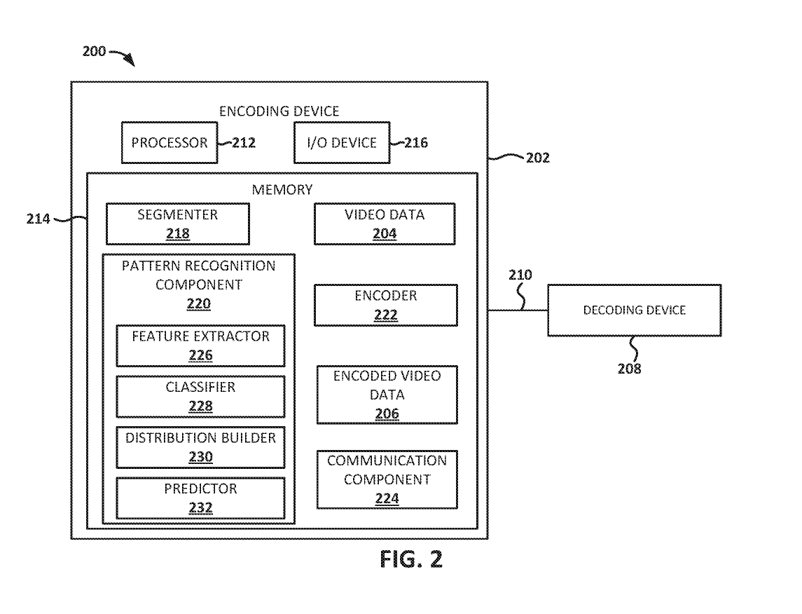

FIG. 2 is a block diagram illustrating an operating environment 200 (and, in some embodiments, aspects of the present invention) in accordance with embodiments of the present invention. The operating environment 200 includes an encoding device 202 that may be configured to encode video data 204 to create encoded video data 206. As shown in FIG. 2, the encoding device 202 may also be configured to communicate the encoded video data 206 to a decoding device 208 via a communication link 210. In embodiments, the communication link 210 may be, include, and/or be included in, a network. The network may be, or include, any number of different types of communication networks such as, for example, a short messaging service (SMS), a local area network (LAN), a wireless LAN (WLAN), a wide area network (WAN), the Internet, a P2P network, and/or the like. The network may include a combination of multiple networks.

As shown in FIG. 2, the encoding device 202 may be implemented on a computing device that includes a processor 212, a memory 214, and an input/output (I/O) device 216. Although the encoding device 202 is referred to herein in the singular, the encoding device 202 may be implemented in multiple instances, distributed across multiple computing devices, instantiated within multiple virtual machines, and/or the like. In embodiments, the processor 212 executes various program components stored in the memory 214, which may facilitate encoding the video data 206. In embodiments, the processor 212 may be, or include, one processor or multiple processors. In embodiments, the I/O device 216 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

According to embodiments, as indicated above, various components of the operating environment 200, illustrated in FIG. 2, may be implemented on one or more computing devices. A computing device may include any type of computing device suitable for implementing embodiments of the invention. Examples of computing devices include specialized computing devices or general-purpose computing devices such as “workstations,” “servers,” “laptops,” “desktops,” “tablet computers,” “hand-held devices,” and the like, all of which are contemplated within the scope of FIG. 1 with reference to various components of the operating environment 200. For example, according to embodiments, the encoding device 202 (and/or the video decoding device 208) may be, or include, a general purpose computing device (e.g., a desktop computer, a laptop, a mobile device, and/or the like), a specially-designed computing device (e.g., a dedicated video encoding device), and/or the like. Additionally, although not illustrated herein, the decoding device 208 may include any combination of components described herein with reference to encoding device 202, components not shown or described, and/or combinations of these.

In embodiments, a computing device includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, the memory 214 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; or any other medium that can be used to store information and can be accessed by a computing device such as, for example, quantum state memory, and the like. In embodiments, the memory 214 stores computer-executable instructions for causing the processor 212 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 218, a pattern recognition component 220, an encoder 222, and a communication component 224. Program components may be programmed using any number of different programming environments, including various languages, development kits, frameworks, and/or the like. Some or all of the functionality contemplated herein may also, or alternatively, be implemented in hardware and/or firmware.

In embodiments, the segmenter 218 may be configured to segment a video frame into a number of segments. The segments may include, for example, objects, groups, slices, tiles, and/or the like. The segmenter 218 may employ any number of various automatic image segmentation methods known in the field. In embodiments, the segmenter 218 may use image color and corresponding gradients to subdivide an image into segments that have similar color and texture. Two examples of image segmentation techniques include the watershed algorithm and optimum cut partitioning of a pixel connectivity graph. For example, the segmenter 218 may use Canny edge detection to detect edges on a video frame for optimum cut partitioning, and create segments using the optimum cut partitioning of the resulting pixel connectivity graph.

In embodiments, the pattern recognition component 220 may perform pattern recognition on digital images such as, for example, frames of video. In embodiments, the pattern recognition component 220 may perform pattern recognition on images that have not been segmented. In embodiments, results of pattern recognition may be used by the segmenter 218 to inform a segmentation process. Pattern recognition may be used for any number of other purposes such as, for example, detecting regions of interest, foreground detection, facilitating compression, and/or the like.

According to embodiments, as shown in FIG. 2, the pattern recognition component 220 includes a feature extractor 226 configured to extract one or more features from an image. In embodiments, the feature extractor 226 may represent more than one feature extractors. The feature extractor 226 may include any number of different types of feature extractors, implementations of feature extraction algorithms, and/or the like. For example, the feature extractor 226 may perform histogram of oriented gradients (HOG) feature extraction, color feature extraction, Gabor feature extraction, Kaze feature extraction, speeded-up robust features (SURF) feature extraction, features from accelerated segment (FAST) feature extraction, scale-invariant feature transform (SIFT) feature extraction, and/or the like.

As is also shown in FIG. 2, the pattern recognition component 220 includes a classifier 228. The classifier 228 may be configured to receive input information and produce output that may include one or more classifications. In embodiments, the classifier may be a binary classifier and/or a non-binary classifier. The classifier may include any number of different types of classifiers such as, for example, a support vector machine (SVM), an extreme learning machine (ELM), a neural network, a kernel-based perceptron, a k-NN classifier, and/or the like. In embodiments, the classifier 228 may be configured to define at least one decision hyperplane that separates a first classification region of a virtual feature space from a second classification region of the virtual feature space.

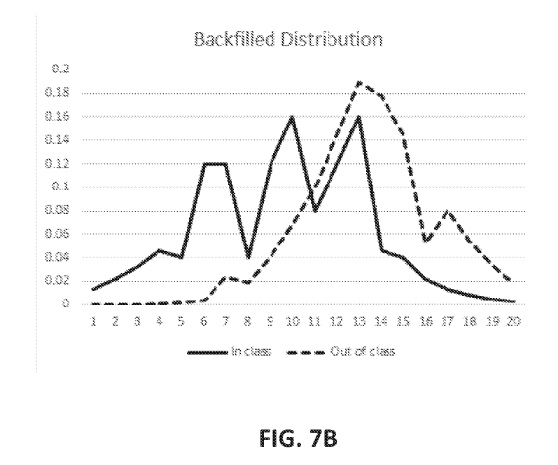

For example, in the case of a binary SVM, embodiments of the learning algorithm include, in simple terms, trying to maximize the average distance to the hyperplane for each label. In embodiments, kernel-based SVMs (e.g., RBF) allow for nonlinear separating planes that can nevertheless be used as a basis for distance measures to each sample point. That is, for example, after an SVM is trained on a test set, distance features may be computed for each sample point between the sample point and the separating hyperplane. The result may be binned into a histogram, as shown, for example, in FIG. 7A. From the example, it will be readily appreciated that a sort of confidence interval can be obtained, for example, by applying Bayesian decision theory. It is worth noting that the “in class” set depicted in FIG. 7A is significantly smaller than the “out of class” set. Because the distribution depicts percentage of samples that falls in each bin, it is possible that some of the discontinuous behavior seen in the “in class” set may be due to insufficient training size.

A similar approach may be taken for the case of an Extreme Learning Machine (ELM). An ELM is a sort of evolution of a neural network that has a series of output nodes, each generally corresponding to a sort of confidence that the sample belongs to class n (where n is the node number). While the ELM isn't necessarily binary in nature, the separate output nodes may allow a similar analysis to take place. In general, for example, the node with the highest output value may be predicted as the classification, but embodiments of the techniques described herein, when applied to the node outputs in a similar way as the SVM decisions, may facilitate significant improvements in performance. According to embodiments, any learning machine with a continuous output may be utilized. Embodiments of the techniques described herein may facilitate boosts in accuracy of classification, as well as more robust characterization of the prediction (e.g., confidence).

The pattern recognition component 220 may include a distribution builder 230 that is configured to receive, from the classifier, a number of classifications corresponding to the input information and to determine a distribution of the classifications. In embodiments, the distribution builder 230 may determine the distributions based on distances between the classifications and the hyperplane.

For example, the distribution builder 230 may be configured to determine the distribution by characterizing the plurality of classifications using a histogram. In embodiments, the distribution builder may be configured to compute a number of distances features, such as, for example, a distance, in the virtual feature space, between each of the classifications and the hyperplane. The distribution builder 230 may assign each of the distance features to one of a number of bins of a histogram.

In the case of sparse or incomplete samples in the histogram, it may be advantageous to model the distribution to generate a projected score for a bin. In the case of sufficient data density (e.g., a significant number of samples fall in the bin of interest), it may be advantageous to use computed probabilities directly. As a result, modeling may be done on a per-bin basis, by checking each bin for statistical significance and backfilling probabilities from the modeled distribution in the case of data that has, for example, a statistically insignificant density, as depicted, for example, in FIG. 7B.

In embodiments, for example, the distribution builder 230 is configured to determine a data density associated with a bin of the histogram, and determine whether the data density is statistically significant. That is, for example, the distribution builder 230 may determine whether the data density of a bin is below a threshold, where the threshold corresponds to a level of statistical significance. If the data density of the bin is not statistically significant, the distribution builder 230 may be configured to model the distribution of data in the bin using a modeled distribution. In embodiments, the Cauchy (also known as the Lorentz) distribution may be used, as it exhibits strong data locality with long tails, although any number of other distributions may be utilized.

Having determined statistical distributions associated with outputs from one or more classifiers, the pattern recognition component 220 may utilize a predictor 232 configured to generate a prediction by estimating, using a decision engine, a probability associated with the distribution. That is, for example, the class with the highest probability predicted by the distribution may be the one selected by the decision engine. A confidence interval may be calculated for each prediction based on the distribution, using any number of different techniques.

In embodiments, for example, the probability for a single classifier may be estimated using an improper Bayes estimation (e.g., a Bayes estimation without previous probability determinations, at least initially). That is, for example, the decision function may be:

$$P ( in class \text{\textbar} distan ce ) = \frac{P ( distance \text{\textbar} in class )}{P ( distance \text{\textbar} in class ) + P ( distance \text{\textbar} out of class )}$$

Using histogram distributions, the P(distance/in/out class) may be calculated by determining percentage of samples in the distance bin, or by substituting an appropriately modeled projection (any of which may be handled by the model internally). Any number of different decision functions may be utilized, and different decision functions may be employed depending on desired system performance, characteristics of the classifier outputs, and/or the like. In embodiments, for example, the decision function may utilize Bayes estimation, positive predictive value (PPV) maximization, negative predictive value (NPV) maximization, a combination of one or more of these, and/or the like. Embodiments of the statistical model described herein may be well suited to a number of decision models as the sensitivity, specificity, and prevalence of the model are all known. Precision and recall may also be determined from the model directly, thereby facilitating potential efficiencies in calculations.

As shown in FIG. 2, the encoding device 202 also includes an encoder 222 configured for entropy encoding of partitioned video frames, and a communication component 224. In embodiments, the communication component 224 is configured to communicate encoded video data 206. For example, in embodiments, the communication component 224 may facilitate communicating encoded video data 206 to the decoding device 208.

The illustrative operating environment 200 shown in FIG. 2 is not intended to suggest any limitation as to the scope of use or functionality of embodiments of the present invention. Neither should the illustrative operating environment 200 be interpreted as having any dependency or requirement related to any single component or combination of components illustrated therein. Additionally, any one or more of the components depicted in FIG. 2 may be, in embodiments, integrated with various ones of the other components depicted therein (and/or components not illustrated), all of which are considered to be within the ambit of the present invention.

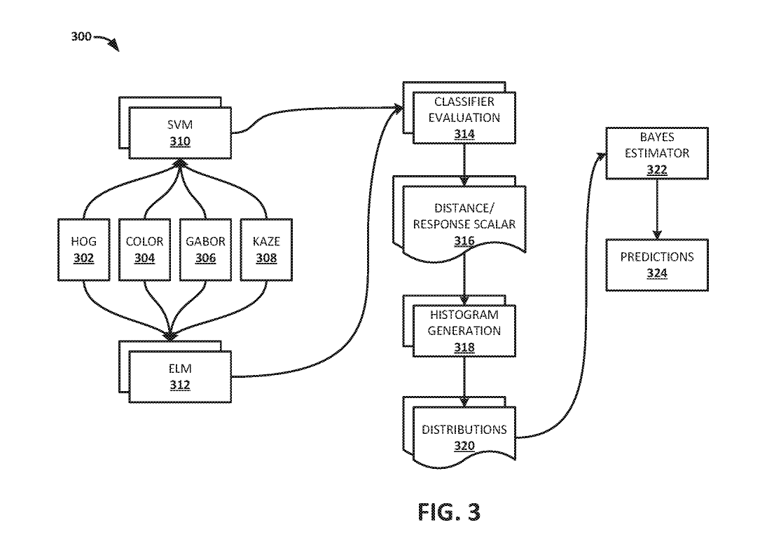

FIG. 3 is a schematic block diagram depicting an illustrative process flow 300 of performing pattern recognition in an image. In embodiments, aspects of the process flow 300 may be performed by an encoding device (e.g., the encoding device 102 depicted in FIG. 1 and/or the encoding device 202 depicted in FIG. 2). As shown in FIG. 3, embodiments of the illustrative process flow 300 may include a number of feature extractors 302, 304, 306, 308 that extract features from an image and provide input information, based on the extracted features, to classifiers 310 and 312. As shown in FIG. 3, the process flow 300 includes a HOG feature extractor 302, a color feature extractor 304, a Gabor feature extractor 306, and a Kaze feature extractor 308. The feature extractors may include, however, any number of different feature extractors. In embodiments, the image may include one or more video frames received by the encoding device from another device (e.g., a memory device, a server, and/or the like). Similarly, the classifiers 310 and 312 include an SVM 310 and an ELM 312; however, any number of different classifiers may be used such as, for example, neural networks, kernel-based perceptron, k-NN classifiers, and/or the like.

In embodiments, the trained classifiers 310 and 312 are used to build distributions that support more robust decision engines. The distribution is generated using a classifier evaluation process 314 that produces a distance/response scalar 316. In embodiments, for example, distances between classification output points and a hyperplane are computed and included in the distance/response scalar 316. The process flow 318 further includes histogram generation 318, through which the distributions 320 are created. A Bayes estimator 322 may be used to generate, based on the distributions 320, predictions 324. According to embodiments, any other prediction technique or techniques.

The illustrative process flow 300 shown in FIG. 3 is not intended to suggest any limitation as to the scope of use or functionality of embodiments of the present invention. Neither should the illustrative operating environment 300 be interpreted as having any dependency or requirement related to any single component or combination of components illustrated therein. Additionally, any one or more of the components depicted in FIG. 3 may be, in embodiments, integrated with various ones of the other components depicted therein (and/or components not illustrated), all of which are considered to be within the ambit of the present invention.

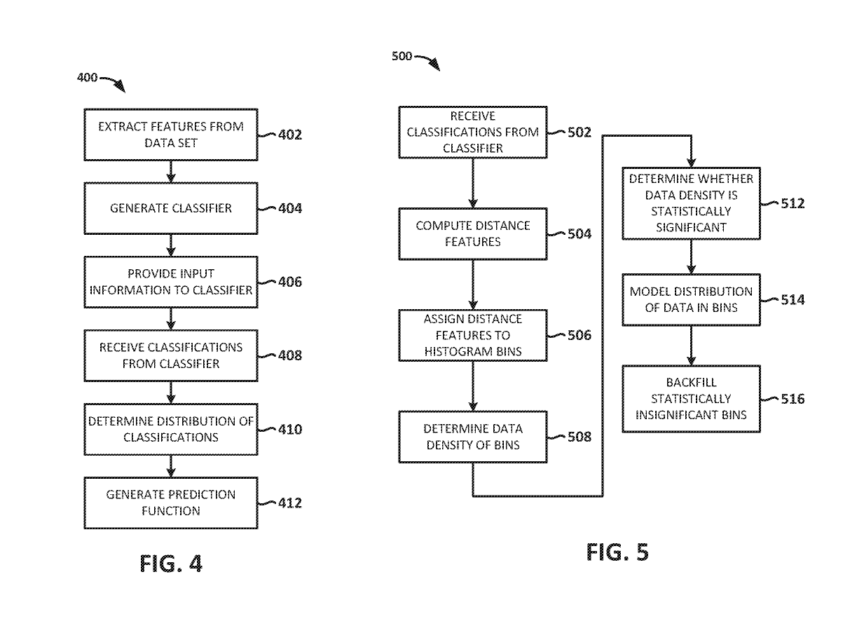

FIG. 4 is a flow diagram depicting an illustrative method 400 of performing object classification training, in accordance with embodiments of the invention. Embodiments of the flow 400 may be utilized, for example, to train one or more classifiers and build classification distributions for use in a pattern matching procedure, and/or the like. In embodiments, aspects of the method 400 may be performed by an encoding device (e.g., the encoding device 102 depicted in FIG. 1 and/or the encoding device 202 depicted in FIG. 2). As shown in FIG. 4, embodiments of the illustrative method 400 may include extracting one or more features from a data set using one or more feature extractors (block 402). In embodiments, the data set may include an image, which may include, for example, one or more video frames received by the encoding device from another device (e.g., a memory device, a server, and/or the like).

Embodiments of the method 400 further include generating at least one classifier (block 404). The at least one classifier may be configured to define at least one decision hyperplane that separates a first classification region of a virtual feature space from a second classification region of the virtual feature space, and may include, for example, at least one of a support vector machine (SVM), an extreme learning machine (ELM), a neural network, a kernel-based perceptron, a k-NN classifier, and/or the like. Input is provided to the classifier (block 406), and a number of classifications is received from the at least one classifier (block 408).

Embodiments of the method 400 include determining a distribution of the plurality of classifications (block 410). In embodiments, determining a distribution of the plurality of classifications includes characterizing the plurality of classifications using a histogram. Embodiments of the method 400 further include generating a prediction function based on the distribution (block 412). According to embodiments, generating the prediction function may include generating a decision function that may be used for estimating, using the decision function, a probability associated with the distribution, where the decision function may utilize at least one of Bayes estimation, positive predictive value (PPV) maximization, negative predictive value (NPV) maximization and/or the like.

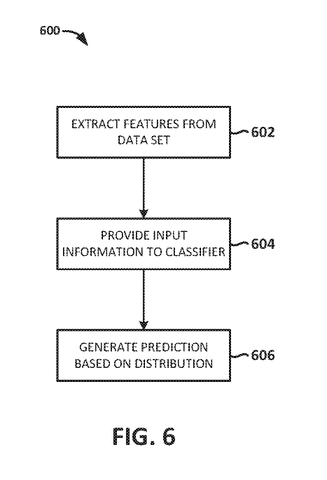

FIG. 5 is a flow diagram depicting an illustrative method 500 of performing object classification training, in accordance with embodiments of the invention. In embodiments, aspects of the method 500 may be performed by an encoding device (e.g., the encoding device 102 depicted in FIG. 1 and/or the encoding device 202 depicted in FIG. 2). As shown in FIG. 5, embodiments of the illustrative method 500 may include receiving, from at least one classifier, a plurality classifications corresponding to the input information (block 502). Embodiments of the method 500 further include computing a number of distances features (block 504). In embodiments, each of the distance features may include a distance, in the virtual feature space, between one of the classifications and the hyperplane.

Embodiments of the method 500 further include assigning each of the distance features to one of a plurality of bins of a histogram (block 506). The method 500 may also include determining a data density associated with a bin of the histogram (block 508); determining that the data density is below a threshold, wherein the threshold corresponds to a level of statistical significance (block 512); and modeling the distribution of data in the bin using a modeled distribution (block 514). For example, in embodiments, the modeled distribution includes a Cauchy distribution. In a final illustrative step of embodiments of the method 500, the bin is backfilled with probabilities from the modeled distribution (block 516).

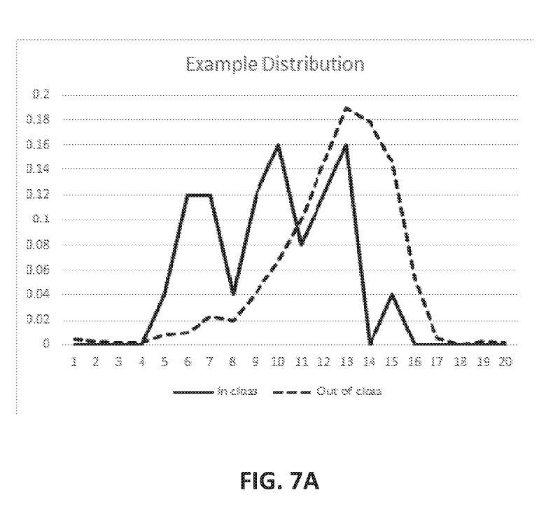

FIG. 6 is a flow diagram depicting an illustrative method 400 of performing object classification, in accordance with embodiments of the invention. Embodiments of the flow 600 may be utilized, for example, in a pattern matching procedure, and/or the like. In embodiments, aspects of the method 600 may be performed by an encoding device (e.g., the encoding device 102 depicted in FIG. 1 and/or the encoding device 202 depicted in FIG. 2). As shown in FIG. 6, embodiments of the illustrative method 600 may include extracting one or more features from a data set using one or more feature extractors (block 602). In embodiments, the data set may include, for example, a digital image. The image may include one or more video frames received by the encoding device from another device (e.g., a memory device, a server, and/or the like).

Embodiments of the method 600 further include providing input information (e.g., the extracted features and/or information derived from the extracted features) to at least one classifier (block 604). The at least one classifier may be configured to define at least one decision hyperplane that separates a first classification region of a virtual feature space from a second classification region of the virtual feature space, and may include, for example, at least one of a support vector machine (SVM), an extreme learning machine (ELM), a neural network, a kernel-based perceptron, a k-NN classifier, and/or the like. Embodiments of the method 600 further include generating a prediction based on the classification distribution provided by the at least one classifier (block 606). According to embodiments, generating the prediction may include using the decision function associated with the distribution, where the decision function may utilize at least one of Bayes estimation, positive predictive value (PPV) maximization, negative predictive value (NPV) maximization and/or the like.

While embodiments of the present invention are described with specificity, the description itself is not intended to limit the scope of this patent. Thus, the inventors have contemplated that the claimed invention might also be embodied in other ways, to include different steps or features, or combinations of steps or features similar to the ones described in this document, in conjunction with other technologies.

The following is claimed:

1. A method of object categorization, the method comprising:
generating at least one classifier, the at least one classifier defining at least one decision hyperplane that separates a first classification region of a virtual feature space from a second classification region of the virtual feature space;
providing input information to the at least one classifier;
receiving, from the at least one classifier, a plurality classifications corresponding to the input information;
determining a distribution of the plurality of classifications; and
generating a prediction based on the distribution.

2. The method of claim 1, wherein determining a distribution of the plurality of classifications comprises characterizing the plurality of classifications using a histogram.

3. The method of claim 2, wherein characterizing the plurality of classifications using a histogram comprises:
computing a plurality of distances features, wherein each of the plurality of distance features comprises a distance, in the virtual feature space, between one of the classifications and the hyperplane; and
assigning each of the plurality of distance features to one of a plurality of bins of a histogram.

4. The method of claim 3, further comprising:
determining a data density associated with a bin of the histogram;
determining that the data density is below a threshold, wherein the threshold corresponds to a level of statistical significance; and
modeling the distribution of data in the bin using a modeled distribution.

5. The method of claim 4, further comprising backfilling the bin with probabilities from the modeled distribution.

6. The method of claim 4, wherein the modeled distribution comprises a Cauchy distribution.

7. The method of claim 1, wherein generating the prediction comprises estimating, using a decision function, a probability associated with the distribution.

8. The method of claim 7, wherein the decision function utilizes at least one of Bayes estimation, positive predictive value (PPV) maximization, and negative predictive value (NPV) maximization.

9. The method of claim 1, wherein the at least one classifier comprises at least one of a support vector machine (SVM), an extreme learning machine (ELM), a neural network, a kernel-based perceptron, and a k-NN classifier.

10. The method of claim 1, further comprising generating the input information by extracting one or more features from a data set using one or more feature extractors.

11. The method of claim 10, wherein the data set comprises digital image data and wherein generating the prediction facilitates a pattern recognition process.

12. A system for object categorization, the system comprising:
a memory having one or more computer-executable instructions stored thereon; and
a processor configured to access the memory and to execute the computer-executable instructions, wherein the computer-executable instructions are configured to cause the processor, upon execution, to instantiate at least one component, the at least one component comprising:
a classifier configured to receive input information, the classifier defining at least one decision hyperplane that separates a first classification region of a virtual feature space from a second classification region of the virtual feature space;
a distribution builder configured to receive, from the classifier, a plurality of classifications corresponding to the input information, and to determine a distribution of the plurality of classifications; and
a predictor configured to generate a prediction based on the distribution.

13. The system of claim 12, wherein the distribution builder is configured to determine the distribution by characterizing the plurality of classifications using a histogram.

14. The system of claim 13, wherein the distribution builder is configured to characterize the plurality of classifications using a histogram by:
computing a plurality of distances features, wherein each of the plurality of distance features comprises a distance, in the virtual feature space, between one of the classifications and the hyperplane; and
assigning each of the plurality of distance features to one of a plurality of bins of a histogram.

15. The system of claim 14, wherein the distribution builder is further configured to characterize the plurality of classifications using a histogram by:
determining a data density associated with a bin of the histogram;
determining that the data density is below a threshold, wherein the threshold corresponds to a level of statistical significance; and
modeling the distribution of data in the bin using a modeled distribution.

16. The system of claim 15, wherein the distribution builder is further configured to characterize the plurality of classifications using a histogram by backfilling the bin with probabilities from the modeled distribution.

17. The system of claim 15, wherein the modeled distribution comprises a Cauchy distribution.

18. The system of claim 12, wherein the predictor is configured to generate the prediction by estimating, using a decision function, a probability associated with the distribution.

19. The system of claim 18, wherein the decision function utilizes at least one of Bayes estimation, positive predictive value (PPV) maximization, and negative predictive value (NPV) maximization.

20. The system of claim 12, wherein the at least one classifier comprises at least one of a support vector machine (SVM), an extreme learning machine (ELM), a neural network, a kernel-based perceptron, and a k-NN classifier.

21. The system of claim 12, further comprising a feature extractor configured to generate the input information by extracting one or more features from a data set.

22. The system of claim 21, wherein the data set comprises digital image data and wherein the predictor facilitates a pattern recognition process.

23. One or more computer-readable media having computer-executable instructions embodied thereon for object categorization, the instructions configured to be executed by a processor and to cause the processor, upon execution, to instantiate at least one component, the at least one component comprising:
a classifier configured to receive input information, the classifier defining at least one decision hyperplane that separates a first classification region of a virtual feature space from a second classification region of the virtual feature space;
a distribution builder configured to receive, from the classifier, a plurality of classifications corresponding to the input information, and to determine a distribution of the plurality of classifications; and
a predictor configured to generate a prediction based on the distribution.
